(19) United States
(12) Patent Application Publication
(10) Pub. No.: US 2023/0142000 A1
(43) Pub. Date: May 11, 2023

(54) Welding Jig Micro-Cleaning Apparatus

(71) Applicant: LG Energy Solution, Ltd., Seoul (KR)

(72) Inventors: Dong Hoon Kwak, Daejeon (KR); Jun Seok Yang, Daejeon (KR)

(73) Assignee: LG Energy Solution, Ltd., Seoul (KR)

(21) Appl. No.: 17/915,347

(22) PCT Filed: Jan. 4, 2022
(86) PCT No.: PCT/KR2022/000081

§ 371 Date: Sep. 28, 2022

(30) Foreign Application Priority Data
Jan. 12, 2021 (KR) 10-2021-0004088

(51) Int. Cl. B23K 9/32; B23K 37/04

(52) U.S. Cl. CPC B23K 9/328; B23K 37/0443

(57) ABSTRACT

The present invention relates to a welding jig micro-cleaning apparatus, and more particularly a welding jig micro-cleaning apparatus including a housing, a sandbox connected to the housing, an air supply unit connected to the sandbox through with a hose, a blasting gun positioned in the housing, a jig fixing portion positioned at a lower first end of the blasting gun, and a controller, wherein the jig fixing portion includes a magnetic unit configured to fix a welding jig.

### CROSS-REFERENCE TO RELATED APPLICATIONS

The present application is a national phase entry under 35 U.S.C. § 371 of International Application No. PCT/KR2022/000081, filed on Jan. 4, 2022, which claims priority from Korean Patent Application No. 10-2021-0004088 filed on Jan. 12, 2021, the disclosure of which is incorporated herein by reference in its entirety.

### TECHNICAL FIELD

The present invention relates to a welding jig micro-cleaning apparatus. More particularly, the present invention relates to a welding jig micro-cleaning apparatus capable of cleaning a laser welding jig using a micro-blaster.

### BACKGROUND ART

Demand for secondary batteries as energy sources for electronic devices, such as mobile phones, laptop computers, and wearable devices, or electric vehicles has increased. Based on the type of electrode, secondary batteries are classified into a nickel-cadmium secondary battery, a nickel-hydride secondary battery, and a lithium secondary battery, and research and development on the lithium secondary battery, which has advantages of high operating voltage and high energy density per unit weight, has been actively conducted.

Based on the shape of a battery case, the lithium secondary battery is classified as a prismatic secondary battery or a cylindrical secondary battery having an electrode assembly mounted in a metal can or a pouch-shaped secondary battery having an electrode assembly mounted in a pouch case made of an aluminum laminate sheet.

For a secondary battery cell, an electrode assembly, obtained by stacking or winding a negative electrode and a positive electrode in the state in which a separator is interposed therebetween, is received in a case, and an electrode tab protruding from the electrode assembly is connected to an electrode lead. The electrode tab and the electrode lead are connected to each other by laser welding or ultrasonic welding. In general, the electrode tab and the electrode lead are fixed to a welding jig, and welding is performed on a welding portion therebetween. When the electrode tab and the electrode lead are welded by ultrasonic welding, however, foreign matter, such as spatter, is generated from the welding portion, and the foreign matter may attached to the welding jig, whereby welding quality between the electrode tab and the electrode lead is lowered.

Meanwhile, Korean Registered Patent Publication No. 10-1988335 discloses a welding nozzle cleaning apparatus including a main body frame unit, an air supply unit coupled to the main body frame unit, a hose unit configured to allow air supplied from the air supply unit to move therethrough, and a collection unit coupled to the main body frame unit, the collection unit being provided at one side thereof with an opening, through which a nozzle is introduced, the hose unit being inserted into the collection unit so as to be coupled thereto; however, the construction of a micro-blaster for cleaning a welding jig is not disclosed.

### DISCLOSURE

### Technical Problem

The present invention has been made in view of the above problems, and it is an object of the present invention to remove pollutants, such as spatter, from a welding jig using a micro-blaster, thereby improving welding quality.

It is another object of the present invention to provide a welding jig micro-cleaning apparatus capable of simplifying a welding jig cleaning operation through a novel welding jig mounting structure, thereby improving cleaning efficiency.

### Technical Solution

In order to accomplish the above objects, a welding jig micro-cleaning apparatus according to the present invention includes a housing (100), a sandbox (200) connected to the housing, an air supply unit (300) connected to the sandbox through a hose, a blasting gun (500) located in the housing, a jig fixing portion (600) located at a lower end of the blasting gun (500), and a controller (400), wherein the jig fixing portion (600) includes a magnetic unit (640) configured to fix a welding jig (700).

In the welding jig micro-cleaning apparatus according to the present invention, the jig fixing portion (600) may include a sliding unit (620) movable horizontally at the lower end of the blasting gun (500).

Also, in the welding jig micro-cleaning apparatus according to the present invention, the sliding unit (620) may be rotatable by a predetermined angle in a horizontal direction.

In the welding jig micro-cleaning apparatus according to the present invention, the blasting gun may include a blasting gun inlet (510) provided at a tip end of the blasting gun (500), wherein the blasting gun inlet (510) may include a discharge port (511) and a suction port (512).

In the welding jig micro-cleaning apparatus according to the present invention, the blasting gun inlet (510) may include a sealing portion (560).

In the welding jig micro-cleaning apparatus according to the present invention, the sealing portion (560) may be brought into tight contact with a die (610) of the jig fixing portion (600) such that the welding jig (700) is located in an inner space of the sealing portion.

In the welding jig micro-cleaning apparatus according to the present invention, the sealing portion (560) may be made of an elastic material.

In the welding jig micro-cleaning apparatus according to the present invention, the blasting gun (500) may be connected to a moving unit so as to be movable upwards and downwards.

In the welding jig micro-cleaning apparatus according to the present invention, the sandbox (200) and the air supply unit (300) may adjust supply amounts of air and sand under control of the controller (400).

In the welding jig micro-cleaning apparatus according to the present invention, the housing (100) may include a housing door (110), and the housing door (110) may include an observation window (120).

In the present invention, one or more constructions that do not conflict with each other may be selected and combined from among the above constructions.

### Advantageous Effects

A welding jig micro-cleaning apparatus according to the present invention is capable of removing pollutants, such as spatter, from a welding jig during a laser welding process, thereby improving laser welding quality.

The present invention has an advantage in that a welding jig cleaning effect is improved through horizontal movement and upward-downward rotation of a jig fixing portion.

The welding jig micro-cleaning apparatus according to the present invention is located in a hermetically sealed housing, whereby it is possible to prevent secondary pollution due to cleaning.

### DESCRIPTION OF DRAWINGS

FIG. 1 is a schematic view of a battery cell according to an embodiment of the present invention.

FIG. 2 is a perspective view showing the external appearance of a welding jig micro-cleaning apparatus according to an embodiment of the present invention.

FIG. 3 is a schematic view of the micro-cleaning apparatus according to the embodiment of the present invention located in a housing of FIG. 2.

FIG. 4 is a schematic view of a blasting gun according to an embodiment of the present invention.

### BEST MODE

In the present application, it should be understood that the terms “comprises,” “has,” “includes,” etc. specify the presence of stated features, numbers, steps, operations, elements, components, or combinations thereof, but do not preclude the presence or addition of one or more other features, numbers, steps, operations, elements, components, or combinations thereof.

In addition, the same reference numbers will be used throughout the drawings to refer to parts that perform similar functions or operations. In the case in which one part is said to be connected to another part in the specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, a micro-cleaning apparatus according to the present invention will be described with reference to the accompanying drawings.

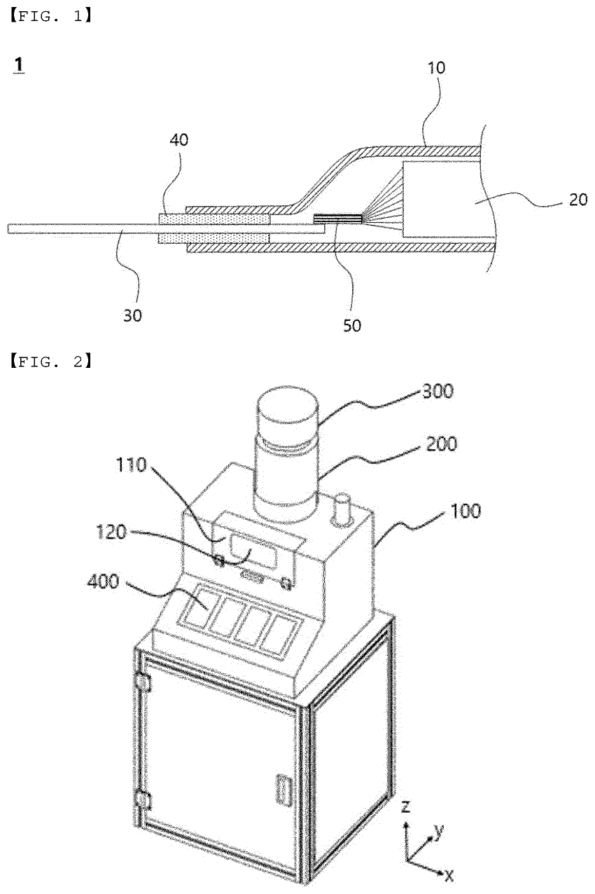

FIG. 1 is a schematic view of a battery cell according to an embodiment of the present invention.

Referring to FIG. 1, the battery cell 1 according to the embodiment of the present invention is a pouch-shaped secondary battery. The battery cell 1 may include a battery case 10, an electrode assembly 20, an electrode lead 30, an insulating tape 40, and an electrode tab 50.

The battery case 10 may define the external appearance of the battery cell 1, and may receive the electrode assembly 20, the electrode lead 30, and the electrode tab 50, a description of which will follow, therein. The battery case 10 may be configured in the form of an aluminum pouch, and an aluminum thin film may be interposed between an insulating layer made of a polymer material and an adhesive layer made of a polymer material of the aluminum pouch.

The electrode assembly 20 may be received in the battery case 10, and may include a positive electrode plate, a negative electrode plate, and a separator. Each of the electrode plates (positive electrode plates and negative electrode plates) of the electrode assembly 20 may be configured to have a structure in which an active material slurry is applied to an electrode current collector. The active material slurry may generally be formed by stirring active material particles, an auxiliary conductor, a binder, and a plasticizer in the state in which a solvent is added thereto. Each electrode plate may have an uncoated portion to which the active material slurry is not applied, and an electrode tab 50, a description of which will follow, corresponding to each electrode plate may be formed at the uncoated portion.

The electrode lead 30 may be electrically connected to the electrode assembly 20, and may protrude outwards from the battery case 10. A pair of electrode leads 30 may be provided, and the pair of electrode leads 30 may include a positive electrode lead and a negative electrode lead.

The pair of electrode leads 30 may be connected to the electrode assembly 20, and may protrude outwards from the battery case 10 in the same direction or in opposite directions.

The insulating tape 40 may be provided so as to correspond in number to the electrode lead 30. In this embodiment, therefore, a pair of insulating tapes 40 may be provided.

The pair of insulating tapes 40 may prevent the occurrence of short circuiting between the battery case 10 and the electrode lead 30 and may increase sealing force of the battery case 10.

The electrode tabs 50 may protrude from the electrode assembly 20 in order to connect the electrode lead 30 and the electrode assembly 20 to each other. Here, the electrode tab 50 may include a positive electrode tab and a negative electrode tab, each of which may be formed so as to protrude from the electrode assembly 20. That is, the positive electrode tab may be formed so as to protrude from the positive electrode plate of the electrode assembly 20, and the negative electrode tab may be formed so as to protrude from the negative electrode plate of the electrode assembly 20.

The electrode tab 50 may include a plurality of positive electrode tabs and a plurality of negative electrode tabs. In this case, the plurality of positive electrode tabs may be connected to the positive electrode lead, which is one of the electrode leads 30, and the plurality of negative electrode tabs may be connected to the negative electrode lead, which is the other of the electrode leads 30.

The electrode tab 50 may be coupled to the electrode lead 30 by laser welding. Laser welding exhibits higher welding strength than ultrasonic welding, i.e. conventional main ultrasonic welding, and does not require a considerable welding width, which is required by the main ultrasonic welding. In addition, for laser welding, problems, such as wear or bending of equipment and burning of the electrode tab 50, do not occur when welding is performed, unlike the conventional main ultrasonic welding.

In addition, for laser welding, the electrode lead 30 and the electrode tab 50 may be fixed and supported by a welding jig. Pollutants, such as spatter, generated during laser welding may attach to the welding jig, which leads to poor welding between the electrode lead 30 and the electrode tab 50.

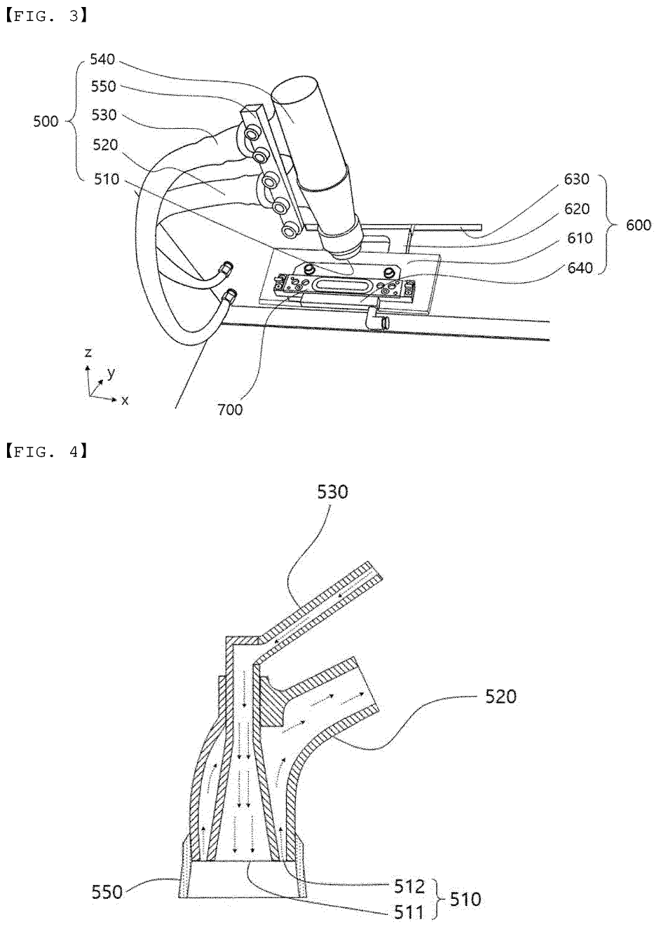

FIG. 2 is a perspective view showing the external appearance of a welding jig micro-cleaning apparatus according to an embodiment of the present invention, FIG. 3 is a schematic view of the micro-cleaning apparatus according to the embodiment of the present invention located in a housing of FIG. 2, and FIG. 4 is a schematic view of a blasting gun according to an embodiment of the present invention.

Referring to FIGS. 2 to 4, the welding jig micro-cleaning apparatus according to the embodiment of the present invention may include a housing 100, a sandbox 200, an air supply unit 300, a controller 400, a jig fixing portion 600, and a blasting gun 500. The jig fixing portion and the blasting gun may be located in the housing 100.

First, when describing the housing 100 in detail, the housing is a portion that defines the external appearance of the welding jig micro-cleaning apparatus. The housing 100 may be formed in a hexahedral shape having an empty inner space. A housing door 110 may be located at an upper part of a front end of the housing 100. The housing door 110 may be configured to open and close a part of a front surface of the housing 100 and a part of an upper end of the housing. After the housing door 110 is opened, a welding jig 700, a description of which will follow, may be mounted to the jig fixing portion 600 located in the housing or may be separated from the jig fixing portion 600 and taken out to the outside. The housing door 110 may be manually opened and closed, and may be connected to an automatic control system so as to be automatically opened and closed as needed. A sealing means may be provided at a portion at which an edge of the housing door 110 and the housing 100 are connected to each other in tight contact with each other in order to hermetically seal the interior of the housing, whereby it is possible to prevent polluted sand or other pollutants dispersed during cleaning from being discharged to the outside.

An observation window 120 may be provided in a front surface (x-z plane) of the housing door 110. Cleaning of the welding jig 700 in the housing 100 may be observed through the observation window 120.

Next, the sandbox 200 and the air supply unit 300 will be described in detail.

The sandbox 200 may be located above the housing 100, and the air supply unit 300 may be connected to the sandbox 200. The sandbox 200 may be formed in an approximately cylindrical shape or an approximately hexahedral shape. However, the shape of the sandbox is not particularly restricted as long as sand and other necessary members can be received in an inner space thereof.

The air supply unit 300 may be an air compressor. Compressed air from the air supply unit 300 may be supplied to the sandbox 200 through a compressed air supply hose (not shown). A compressed air distribution means (not shown), a cut-off valve (not shown), a pressure control valve (not shown), and a flow control valve (not shown) may be disposed in the compressed air supply hose. Compressed air from the air supply unit 300 may be supplied to the sandbox 200 and other rear equipment through the compressed air distribution means.

First compressed air (not shown), which is some of compressed air from the air supply unit 300, may be supplied to the sandbox 200 through a connection pipe (not shown) so as to be mixed with sand.

A sand and air discharge port (not shown) may be located at a lower end of the sandbox 200, and a three-way valve (not shown) may be located in the air discharge port. Sand and air mixed in the sandbox 200 may be introduced into a first hole of the three-way valve, and second compressed air (not shown), which is compressed air from the air supply unit 300, may be introduced into a second hole of the three-way valve. The compressed air introduced into the second hole and the sand and air mixture introduced into the first hole may be discharged together through a third hole of the three-way valve. Here, the third hole may be connected to a supply hose 530 in order to transfer the sand supplied from the sandbox 200 to the blasting gun 500. The amount and flow speed of sand supplied to the supply hose 530 may be adjusted using the first compressed air and the second compressed air, and a control valve (not shown) may be mounted on a transfer line for the first compressed air and the second compressed air in order to adjust the flow rate of compressed air.

Next, the controller 400 will be described.

The controller 400 according to the present invention may be connected to a side surface of the housing 100. The controller 400 may control driving of the air supply unit 300, operation of the control valve (not shown) configured to adjust flow rate of compressed air, upward and downward movement of a support portion 550 of the blasting gun 500, a description of which will follow, on and off of a magnetic unit, and horizontal movement and rotation of a sliding unit 620, a description of which will follow.

Next, the blasting gun 500 will be described.

In the present invention, a supply hose 530 connected to the third hole of the three-way valve located at the lower end of the sandbox 200 is connected to the blasting gun 500 to supply the sand and the compressed air discharged from the third hole of the three-way valve to the blasting gun 500. A discharge hose 520 is located spaced apart from the supply hose 530 by a predetermined distance, and the supply hose 530 and the discharge hose 520 extend into a body portion 540 so as to be connected to the body portion 540. Flow of a fluid in the supply hose 530, the discharge hose 520, and the body portion 540 will be described below in detail. The sand and the compressed air introduced into the body portion 540 through the supply hose 530 are sprayed through a blasting gun inlet 510 to remove pollutants from the welding jig 700, a description of which will follow. The body portion 540, which is connected to the supply hose 530 and the discharge hose 520, may be fixed to a side wall of the housing 100 via the support portion 550. In addition, the support portion 550 may be controlled by the controller so as to be movable upwards and downwards. The support portion 550 may be coupled to a vertical moving cylinder (not shown) so as to be movable upwards and downwards, and the vertical moving cylinder may be controlled by the controller 400.

Referring to FIG. 4, the blasting gun inlet 510 may include a discharge port 511 and a suction port 512. The discharge port 511 may be located at a tip end of an internal flow path (not shown) of the body portion 540 to which the supply hose 530 extending into the body portion 540 is connected. The discharge port 511 may spray the sand and the compressed air supplied from the supply hose 530 to the welding jig 700, a description of which will follow, disposed thereunder in order to clean the welding jig. The internal flow path of the body portion 540 may be a hose or a stainless steel pipe. A partition wall of the body portion 540 is spaced apart from a partition wall of the internal flow path while wrapping the internal flow path of the body portion 540, whereby a space functioning as an external flow path (not shown) is formed. The partition wall of the body portion 540 and the partition wall of the internal flow path are spaced apart from each other, whereby the suction port 512 is formed at a tip end of the blasting gun inlet 510. The suction port 512 is located around the discharge port 511. The discharge hose 520 is connected to the body portion 540 through the partition wall of the body portion so as to be opposite the suction port 512 in the state in which the external flow path is located therebetween. During a process in which the sand and the compressed air are sprayed through the discharge port 511 to remove pollutants from the welding jig 700 in order to clean the welding jig, the sprayed sand and the pollutants separated from the welding jig 700 are suctioned through the suction port 512.

A sealing portion 560 may be located at an external partition wall around the blasting gun inlet 510. The sealing portion 560 may be coupled to the circumference of the blasting gun inlet 510 so as to extend outwards from the body portion 540, or may be configured to receive the welding jig 700 mounted to the jig fixing portion 600, a description of which will follow, therein.

A tip end surface of the sealing portion 560 may be brought into tight contact with an upper end surface of a die 610, a description of which will follow, and specifically may be made of an elastic material, such as silicone or synthetic rubber. The reason for this is that, when the jig fixing portion 600 is moved leftwards and rightwards or upwards and downwards, the jig fixing portion comes into contact with the sealing portion 560, whereby damage, such as scratch, to the welding jig 700 mounted to the jig fixing portion 600 is prevented. In addition, the sealing portion 560 may be permanently fixed to the circumference of the blasting gun inlet 510 by adhesion, or may be detachably attached thereto through an attachment and detachment means. Here, the tip end surface of the sealing portion 560, which is brought into tight contact with the die 610, a description of which will follow, may be coated with a metal material. In this case, the extent of tight contact between the sealing portion and the die 610 is improved by a magnetic unit 640, a description of which will follow, which is advantageous in suctioning the removed pollutant, such as spatter.

Next, the jig fixing portion 600 will be described in detail.

The jig fixing portion 600 may be located under the blasting gun 500, and may include a die 610, a sliding unit 620, a sliding slit 630, and a magnetic unit 640. The welding jig 700 is located at an upper end of the die 610 so as to be cleaned by the sand and the compressed air sprayed from the discharge port 511 of the blasting gun 500. The die 610 may have a plate shape. The magnetic unit 640 may be located at the die 610 in order to fix the welding jig 700, whereby it is possible to prevent separation or displacement of the welding jig 700 during a cleaning process. The magnetic unit 640 may be constituted by a permanent magnet or an electromagnet. In the case in which the magnetic unit is constituted by an electromagnet, an on-off lever (not shown) may be provided. The magnetic unit 640 may be magnetized or demagnetized by manipulation of the on-off lever. In addition, magnetic force of the magnetic unit may be controlled. In the present invention, therefore, it is preferable for the magnetic unit 640 to be constituted by an electromagnet.

The die 610 may be connected to the sliding unit 620, and the sliding unit 620 may be connected to a rear sliding driving portion (not shown) through the sliding slit 630, which is formed in the partition wall of the housing 100. The sliding unit 620 may be moved leftwards and rightwards in a horizontal direction by manipulation of the sliding driving portion. After the welding jig 700 is mounted to the upper end of the die 610, the welding jig 700 may be moved under the blasting gun inlet 510 through operation of the sliding unit 620, and cleaning may be performed.

In addition, a hinge coupling portion (not shown) provided at the sliding unit 620 to allow the die 610 to be rotated by a predetermined angle may be included. As a result, a disposition angle of the welding jig 700 may be adjusted, which is advantageous in effectively removing pollutants from a bent portion of the welding jig 700 through cleaning.

Although the specific details of the present invention have been described in detail, those skilled in the art will appreciate that the detailed description thereof discloses only preferred embodiments of the present invention and thus does not limit the scope of the present invention. Accordingly, those skilled in the art will appreciate that various changes and modifications are possible, without departing from the category and technical idea of the present invention, and it will be obvious that such changes and modifications fall within the scope of the appended claims.

### DESCRIPTION OF REFERENCE NUMERALS

1: Battery cell
10: Battery case
20: Electrode assembly
30: Electrode lead
40: Insulating tape
50: Electrode tab
100: Housing
110: Housing door
120: Observation window
200: Sandbox
300: Air supply unit
400: Controller
500: Blasting gun
510: Blasting gun inlet
511: Discharge port
512: Suction port
520: Discharge hose
530: Supply hose
540: Body portion
550: Support portion
560: Sealing portion
600: Jig fixing portion
610: Die
620: Sliding unit
630: Sliding slit
640: Magnetic unit
700: Welding jig

1. A welding jig micro-cleaning apparatus comprising:
a housing;
a sandbox connected to the housing;
an air supply unit connected to the sandbox with a hose;
a blasting gun positioned in the housing;
a jig fixing portion positioned at a first end of the blasting gun; and
a controller,
wherein the jig fixing portion comprises a magnetic unit configured to fix a welding jig.

2. The welding jig micro-cleaning apparatus according to claim 1, wherein the jig fixing portion comprises a sliding unit movable in first and second opposing directions at the first end of the blasting gun.

3. The welding jig micro-cleaning apparatus according to claim 2, wherein the sliding unit is rotatable by a predetermined angle in a one of the first and second directions.

4. The welding jig micro-cleaning apparatus according to claim 1, wherein the blasting gun comprises a blasting gun inlet provided at a tip end of the blasting gun, and
wherein the blasting gun inlet comprises a discharge port and a suction port.

5. The welding jig micro-cleaning apparatus according to claim 4, wherein the blasting gun inlet comprises a sealing portion.

6. The welding jig micro-cleaning apparatus according to claim 5, wherein the sealing portion contacts a die of the jig fixing portion such that the welding jig is positioned in an inner space of the sealing portion.

7. The welding jig micro-cleaning apparatus according to claim 5, wherein the sealing portion is made of an elastic material.

8. The welding jig micro-cleaning apparatus according to claim 1, wherein the blasting gun is connected to a moving unit so as to be movable in first and second opposing directions.

9. The welding jig micro-cleaning apparatus according to claim 1, wherein the sandbox and the air supply unit are configured to adjust supply amounts of air and sand under control of the controller.

10. The welding jig micro-cleaning apparatus according to claim 1, wherein the housing comprises a housing door, and
wherein the housing door comprises an observation window.
